(19) United States
(12) Patent Application Publication
(10) Pub. No.: US 2017/0145209 A1
(43) Pub. Date: May 25, 2017

(54) RESIN COMPOSITION AND ELECTRICAL DEVICE

(71) Applicant: HITACHI, LTD., Tokyo (JP)

(72) Inventors: Yuri KAJIHARA, Tokyo (JP); Satoru AMOU, Tokyo (JP); Takahito MURAKI, Tokyo (JP)

(73) Assignee: HITACHI, LTD., Tokyo (JP)

(21) Appl. No.: 15/316,224

(22) PCT Filed: May 18, 2015
(86) PCT No.: PCT/JP2015/064130

§ 371 Date: Dec. 5, 2016

(30) Foreign Application Priority Data
Jun. 13, 2014 (JP) 2014-121970

(51) Int. Cl. C08L 63/00; H01B 3/44; H01B 3/42; C08F 222/08; H01B 3/40

(52) U.S. Cl. CPC C08L 63/00; C08F 222/08; H01B 3/40; H01B 3/425; H01B 3/442; C08L 2201/08; C08F 2800/10

(57) ABSTRACT

It is an object of the present invention to provide an excellent thermosetting resin that achieves both higher heat resistance and higher toughness and mechanical strength for improving cracking resistance and lower viscosity which are conventionally in a trade-off relationship. It is also an object of the present invention to provide an electronic•electrical device using a cured product of the thermosetting resin as an insulating material or a structural material. The present invention includes a plurality of means for achieving the above objects, and one of the means is a thermosetting resin composition comprising: a three-dimensional copolymer obtained by copolymerizing a maleimide derivative and a styrene derivative with use of an alkyl borane or a boron compound as a polymerization initiator; and a thermosetting resin composition.

### TECHNICAL FIELD

The present invention relates to a resin composition containing a three-dimensional copolymer and a thermosetting resin composition and an electrical device using a cured product of the resin composition as an insulating material or a structural material.

### BACKGROUND ART

Electronic•electrical devices have become more compact and lighter. This increases the current density of the devices and the amount of heat generated by the devices. Therefore, insulating materials used for the devices are required to have higher heat resistance. On the other hand, as insulating materials of electrical devices, thermosetting resins have been widely used which are typified by epoxy resins offering an excellent balance of low cost, high adhesiveness, heat resistance, and processability. Examples of a method for enhancing the heat resistance of an epoxy resin include introduction of a rigid structure such as a naphthalene skeleton and application of a multi-functional epoxy resin having three or more epoxy groups in its structure.

Meanwhile, the resins are required to have not only higher heat resistance but also improved cracking resistance and, from the viewpoint of processability, lower viscosity. However, the above-described method for enhancing heat resistance has a problem such as a reduction in toughness or an increase in viscosity. Examples of a method for enhancing toughness, that is, achieving higher toughness include improvement of a resin or a curing agent and improvement by adding a modifier. More specifically, improvement of a resin or a curing agent is achieved by enhancing the toughness of skeleton or molecular chain of a matrix resin. Further, improvement by adding a modifier is achieved by adding rubber or an elastomer having flexibility or a tough thermoplastic polymer to a resin system. However, any of these methods has a problem such as a reduction in heat resistance or an increase in viscosity. That is, higher heat resistance, higher toughness for improving cracking resistance, and lower viscosity are in a trade-off relationship.

PTL 1 reports a method for enhancing the toughness of an epoxy resin by adding a copolymer including N-phenylmaleimide, N-cyclohexylmaleimide, and styrene. This method does not cause a reduction in heat resistance or a reduction in mechanical strength such as bending properties. In such a known example, excellent toughness is imparted by adding a specified amount of the copolymer including N-phenylmaleimide, N-cyclohexylmaleimide, and styrene. However, there is no description about a reduction in viscosity.

### CITATION LIST

### Patent Literature

PTL 1: JP-2007-91857 A

### SUMMARY OF INVENTION

### Technical Problem

It is an object of the present invention to provide an excellent thermosetting resin that achieves both higher heat resistance and higher toughness and mechanical strength for improving cracking resistance and lower viscosity which are conventionally in a trade-off relationship. It is also an object of the present invention to provide an electronic•electrical device using a cured product of the thermosetting resin as an insulating material or a structural material.

### Solution to Problem

The present invention includes a plurality of means for achieving the above objects, and one of the means is a thermosetting resin composition containing a three-dimensional copolymer obtained by copolymerizing a maleimide derivative and a styrene derivative with use of an alkyl borane or a boron compound as a polymerization initiator and a thermosetting resin composition.

### Advantageous Effects of Invention

According to the present invention, it is possible to provide an excellent thermosetting resin composition that achieves both higher heat resistance and higher toughness and mechanical strength for improving cracking resistance and lower viscosity.

### BRIEF DESCRIPTION OF DRAWINGS

FIG. 1 is a sectional view of a cured resin according to the present invention.

FIG. 2 is a diagram showing a coil for electrical device.

FIG. 3 is a diagram showing a rotating electrical machine.

FIG. 4 is a ¹H-NMR spectrum of a compound 1.

FIG. 5 is a ¹H-NMR spectrum of a compound 2.

### DESCRIPTION OF EMBODIMENTS

Hereinbelow, embodiments of the present invention will be described with reference to the drawings.

A resin composition according to the present invention is a thermosetting resin composition containing a three-dimensional copolymer obtained by copolymerizing a maleimide derivative (N-phenylmaleimide, N-cyclohexylmaleimide) and a styrene derivative with use of an alkyl borane or a boron compound as a polymerization initiator and a thermosetting resin composition.

The resin composition according to the present invention contains a block copolymer represented by Formula 1 or 2.

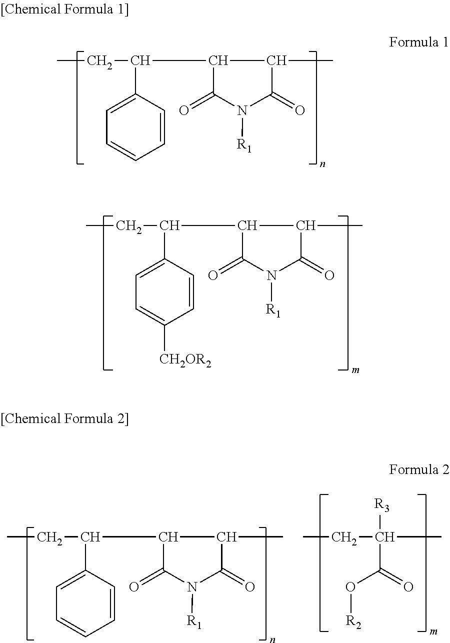

More specifically, the resin composition represented by Formula 1 is a block copolymer including a block including a repeating unit represented by Formula I and a block including a repeating unit represented by Formula II. The resin composition represented by Formula 2 is a block copolymer including a block including a repeating unit represented by Formula I and a block including a repeating unit represented by Formula III.

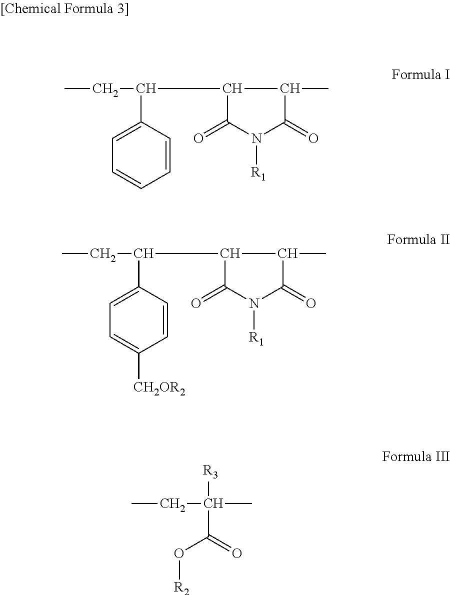

In the resin composition according to the present invention, the block copolymer represented by Formula 1 or 2 is obtained by copolymerization using an alkyl borane as a polymerization initiator. An alkyl borane or a boron compound functions as a living radical polymerization initiator, and therefore the block copolymer represented by Formula 1 or 2 is a polymer obtained by living radical polymerization.

In a conventional radical polymerization reaction using, as a polymerization initiator, an azo compound such as 2,2-azobisisobutyronitrile (AIBN) or a peroxide such as benzoyl peroxide or dicumyl peroxide (DICUP), termination caused by disproportionation or recombination is likely to occur. As a result of such termination, bonds that are weak against thermal decomposition are formed. On the other hand, in a living radical polymerization reaction, termination is less likely to occur, which prevents the formation of bonds that are weak against thermal decomposition. Therefore, also in the case of the block copolymer according to the present invention represented by Formula 1 or 2 obtained by polymerization using, as a polymerization initiator, an alkyl borane or a boron compound, formation of bonds that are weak against thermal decomposition is prevented. For the above reason, the block copolymer according to the present invention represented by Formula 1 or 2 has a higher decomposition temperature than a block copolymer obtained by polymerization using an azo compound or a peroxide, which enhances heat resistance.

In the resin according to the present invention, the three-dimensional copolymer is represented by Formula 1 or 2, wherein R1 is any one of a phenyl group, a substituted phenyl group, a cyclohexyl group, and an alkyl group having 1 to 6 carbon atoms.

The substituted phenyl group is a phenyl group substituted with at least one substituent group selected from the group consisting of an alkyl group having 4 or less carbon atoms, a cyano group, a methoxy group, and a halogen.

Examples of the alkyl group having 1 to 6 carbon atoms include a methyl group, an ethyl group, a propyl group, a butyl group, a pentyl group, and a hexyl group. Among them, a methyl group, an ethyl group, and a propyl group are preferred.

R2 is —(CH₂CH₂O)ₚR4. p is an integer of 1 to 150. Particularly, p is preferably an integer of 10 to 60 in consideration of a balance between compatibility developed by polyether chains and water resistance.

R4 is any one of a phenyl group, a substituted phenyl group, a cyclohexyl group, and an alkyl group having 1 to 6 carbon atoms. The substituted phenyl group is at least one substituent group selected from the group consisting of an alkyl group having 4 or less carbon atoms, a cyano group, a methoxy group, and a halogen. Examples of the alkyl group having 1 to 6 carbon atoms include a methyl group, an ethyl group, a propyl group, a butyl group, a pentyl group, and a hexyl group. Among them, a methyl group, an ethyl group, and a propyl group are preferred. R4 is preferably an alkyl group having 1 to 6 carbon atoms and is more preferably a methyl group from the viewpoint of compatibility, control of a phase structure after thermal curing, and a balance of bending properties.

R3 is a hydrogen atom or a methyl group, and is preferably a methyl group from the viewpoint of ease of polymer synthesis. The ratio between n and m (n/m) is 1000/1 to 80/20. n is an integer of 4 or more, preferably an integer of 80 to 1000, and m is an integer of 1 or more, preferably an integer of 1 to 20.

The compound represented by Formula 1 and the compound represented by Formula 2 preferably have a weight-average molecular weight of 5000 to 700000, more preferably 10000 to 500000. When the weight-average molecular weight is within the above range, the viscosity of the uncured resin can be kept low, and therefore excellent workability is achieved. It is to be noted that the weight-average molecular weight is a value determined by gel permeation chromatography using polystyrene standards.

The compound represented by Formula 1 and the compound represented by Formula 2 preferably have a glass transition temperature (Tg) of 190 to 240° C. It is to be noted that Tg is a temperature measured by differential scanning calorimetry (DSC).

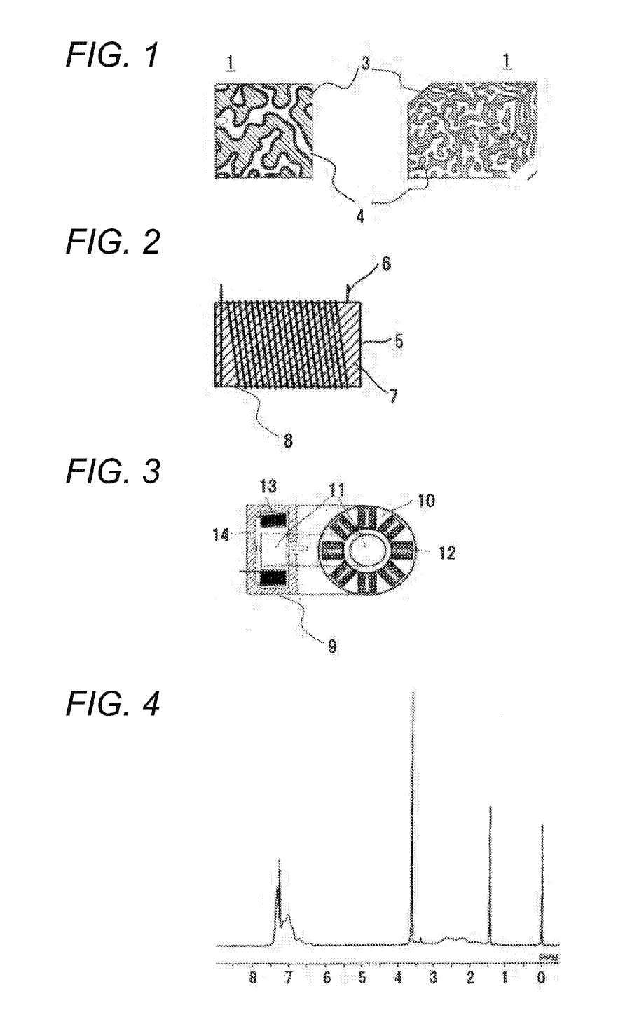

FIG. 1 shows a cured resin 1 according to the present invention. In FIG. 1, the resin composition 1 is two-dimensionally shown on the left side, and is three-dimensionally shown on the right side. In the present invention, a three-dimensional copolymer 4 forms a bicontinuous phase structure with a thermosetting resin composition 3. The bicontinuous phase structure functions as a pathway that disperses external stress, which enhances toughness. Further, the three-dimensional copolymer 4 has properties close to those of a thermoplastic resin, and is therefore more flexible than a thermosetting resin. This flexibility relaxes stress, which enhances toughness. For the above reason, the resin composition 1 according to the present invention having a bicontinuous phase structure formed by the three-dimensional copolymer 4 and the thermosetting resin composition 3 has enhanced toughness.

The compound represented by Formula 1 can be obtained by, for example, mixing monomers represented by Formulas 3 to 5 and an alkyl borane or a boron compound in an organic solvent such as acetone and reacting the mixture at about 10 to 80° C. for 6 to 10 hours.

The compound represented by Formula 2 can be obtained by, for example, mixing monomers represented by Formulas 3, 4 and 6 and an alkyl borane or a boron compound in an organic solvent such as acetone and reacting the mixture at about 10 to 80° C. for 6 to 10 hours.

Alternatively, the compound represented by Formula 1 or Formula 2 may be obtained by mixing monomers represented by Formulas 3 to 5 or monomers represented by Formulas 3, 4, and 6, respectively, and an alkyl borane or a boron compound in at least one thermosetting resin composition selected from the group consisting of an epoxy resin, a cyanate resin, a bismaleimide resin, and an unsaturated polyester resin.

In the case of this method, a monomer such as a divinyl benzene compound, a diacrylate, or a triacrylate may further be added and copolymerized with the monomers represented by Formulas 3 to 6. The addition of a divinyl benzene compound, a diacrylate, or a triacrylate is effective at enhancing heat resistance and solvent resistance.

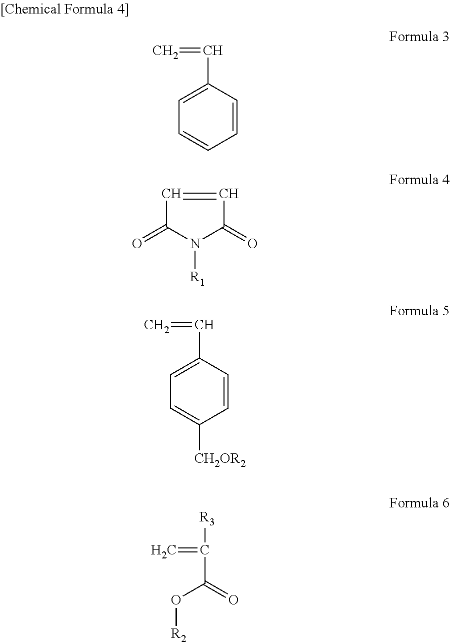

In the resin composition according to the present invention, a divinyl benzene compound, a diacrylate, or a triacrylate functions as a cross-linking agent. For example, when a divinyl benzene compound is added, an interpenetrating polymer network (IPN) structure is formed in the resin composition, which enhances mechanical properties. Unlike a conventional polymer blend, the IPN structure is a structure in which the network chains of the individual cross-linked polymer components are tangled with each other. The tangles of the network chains make it possible to improve compatibility between the individual molecular chains, and further the formation of an interpenetrating polymer network structure improves interfacial adhesiveness between the three-dimensional copolymer and the thermosetting resin composition.

A specific example of the divinyl compound includes divinyl benzene. A specific example of the diacrylate includes neopentyl glycol dimethacrylate. Specific examples of the triacrylate include trimethylol propane triacrylate and isocyanuric acid-modified triacrylate.

In the present invention, an alkyl borane or a boron compound initiates a polymerization reaction at low temperature. Also when the compound represented by Formula 1 or 2 is obtained in the thermosetting resin composition, a reaction is performed at about 10 to 80° C. for 6 to 10 hours.

When an azo compound such as 2,2-azobisisobutyronitrile (AIBN) or a peroxide such as benzoyl peroxide or dicumyl peroxide (DICUP) is used as a polymerization initiator, an optimum temperature at which the polymerization initiator functions is about 80 to 130° C. Therefore, the whole of a reaction system needs to be heated to 80 to 130° C. to obtain the compound represented by Formula 1 in the thermosetting resin composition with use of an azo- or peroxide-based polymerization initiator. However, the polymerization of the thermosetting resin composition also gradually proceeds at such a temperature, which causes an increase in viscosity.

The viscosity is preferably 200 to 1000 mPa·s, and is more preferably 200 to 700 mPa·s. If the viscosity exceeds the above upper limit, workability is poor or voids are likely to be formed.

On the other hand, in the present invention, an alkyl borane or a boron compound initiates a polymerization reaction at low temperature, and therefore the temperature of a polymerization reaction for obtaining the compound represented by Formula 1 or 2 may be about 10 to 80° C. The temperature of the polymerization reaction is more preferably 30 to 60° C. The polymerization of the thermosetting resin composition does not proceed at such a temperature, which prevents an increase in viscosity.

The method in which the compound represented by Formula 1 or 2 is produced in the thermosetting resin composition is preferred from the viewpoint of a reduction in VOCs, shortening of a working process, and an improvement in workability during production and use of the composition due to a reduction in viscosity.

Hereinbelow, the thermosetting resin composition according to the present invention will be described in detail.

The resin composition according to the present invention (hereinafter, also referred to as a “composition according to the present invention”) is a thermosetting resin composition containing at least one thermosetting resin selected from the group consisting of an epoxy resin, a cyanate resin, and a bismaleimide resin, and the above-described compound represented by Formula 1 or 2 (three-dimensional copolymer), wherein the compound represented by Formula 1 or 2 is contained in an amount of 1 to 30 parts by mass per 100 parts by mass of the thermosetting resin.

The compound represented by Formula 1 or 2 is contained in an amount of 1 to 30 parts by mass per 100 parts by mass of the thermosetting resin. When the compound represented by Formula 1 or 2 is contained in an amount within the above range, the bending strength and bending elastic modulus of a cured product of the resulting composition can be maintained, which makes it possible to enhance toughness. From the viewpoint of obtaining a cured product that simultaneously achieves these properties at higher levels, the compound represented by Formula 1 or 2 is preferably contained in an amount of 1 to 20 parts by mass per 100 parts by mass of the thermosetting resin.

It is to be noted that when the composition according to the present invention contains both the compound represented by Formula 1 and the compound represented by Formula 2, the above-described amount of the compound means the total amount of these compounds, and when the composition according to the present invention contains only one of the compounds, the above-described amount of the compound means the amount of one of the compounds.

The epoxy resin for use in the resin composition according to the present invention is a compound having at least one epoxy group, and is not particularly limited. Specific examples of the epoxy resin include various epoxy resins such as a bisphenol A-type epoxy resin obtained by a reaction between bisphenol A and epichlorohydrin, a brominated epoxy resin, a bisphenol F-type epoxy resin, a novolac-type epoxy resin, an alicyclic epoxy resin, triglycidyl isocyanurate (TGIC), a bisphenol S-type epoxy resin, a phenol novolac-type epoxy resin, and a cresol novolac-type epoxy resin, and modified epoxy resins thereof. These epoxy resins may be used singly or in combination of two or more of them.

From the viewpoint of obtaining a cured product having excellent mechanical strength and heat resistance, the epoxy resin preferably has at least one aromatic ring. Particularly, a bisphenol A-type epoxy resin, a cresol novolac-type epoxy resin, tetraglycidyl diaminodiphenyl methane (TGDDM), a dicyclopentadienyl-type epoxy resin, triglycidylpara-aminophenol, and triglycidyl meta-aminophenol are preferred from the viewpoint of excellent workability, heat resistance, and water resistance.

The epoxy equivalent of the epoxy resin is not particularly limited, and may be appropriately selected depending on the intended use. The epoxy equivalent is preferably about 100 to 1000, more preferably about 100 to 500. When the epoxy equivalent is within the above range, the epoxy resin is easily mixed with the above-described compound according to the present invention, which makes it possible to more effectively enhance the toughness of the epoxy resin.

The cyanate resin for use in the resin composition according to the present invention is not particularly limited as long as the cyanate resin is a compound having a cyanate group (—OCN) at its end. Specific preferred examples of such a cyanate resin include aromatic cyanate compounds such as 1,1′-bis(4-cyanatophenyl)ethane, bis(4-cyanato-3,5-dimethylphenyl)methane, 1,3-bis(4-cyanatophenyl-1-(1-methylethylidene))benzene, cyanated phenol•dicyclopentadiene adduct, a cyanated novolac resin, bis(4-cyanatophenyl)thioether, bis(4-cyanatophenyl)ether, resorcin dicyanate, 2,2′-bis(4-cyanatophenyl)isopropylidene, 2,2′-bis(4-cyanatophenyl)-1,1,1,3,3,3-hexafluoroisopropylidene, 1,1,1-tris(4-cyanatophenyl)ethane, and 2-phenyl-2-(4-cyanatophenyl)isopropylidene. The cyanate resin may be produced by a known method or may be a commercially-available product. A preferred example of the commercially-available product is an aromatic cyanate compound manufactured by Huntsman Corporation.

The maleimide resin for use in the resin composition according to the present invention is not particularly limited, and may be a known maleimide resin. A specific preferred example of the maleimide resin is an aromatic bismaleimide. The aromatic bismaleimide can be obtained by a known method in which a corresponding aromatic diamine and maleic anhydride are reacted. Specific examples of the aromatic bismaleimide include N,N′-m-phenylene bismaleimide, N,N′-p-phenylene bismaleimide, N,N′-m-toluylene bismaleimide, N,N′-4,4′-biphenylene bismaleimide, N,N′-4,4′-(3,3′-dimethylbiphenylene)bismaleimide, 2,2-bis[4-(4-maleimidephenoxy)phenyl]propane, and bismaleimide represented by the following Formula 7.

In Formula 7, X is —CH₂—, —C(CH₃)₂—, —SO₂—, —SO—, or —O—.

Specific examples of the bismaleimide represented by Formula 7 include N,N′-4,4′-(3,3′-dimethyldiphenylmethane)bismaleimide, N,N′-4,4′-(3,3′-diethyldiphenylmethane)bismaleimide, N,N′-4,4′-diphenylmethane bismaleimide, N,N′-4,4′-2,2-diphenylpropane bismaleimide, N,N′4,4′-diphenylether bismaleimide, N,N′-3,3′-diphenylsulfone bismaleimide, N,N′-4,4′-diphenylsulfone bismaleimide, N,N′-4,4′-diphenylsulfoxide bismaleimide, N,N′-4,4′-diphenylsulfide bismaleimide, and N,N′-4,4′-benzophenone bismaleimide. Among them, N,N′-4,4′-diphenylmethane bismaleimide (BDM), N,N′-4,4′-diphenylether bismaleimide, N,N′-m-toluylene bismaleimide, 2,2-bis[4-(4-maleimidephenoxy)phenyl]propane, N,N′-4,4′-diphenylsulfone bismaleimide, and N,N′-4,4′-benzophenone bismaleimide are preferred from the viewpoint of obtaining a cured product of the composition having excellent heat resistance. Particularly, N,N′-4,4′-diphenylmethane bismaleimide, N,N′-4,4′-diphenylether bismaleimide, N,N′-m-toluylene bismaleimide, and 2,2-bis[4-(4-maleimidephenoxy)phenyl]propane are more preferred.

These aromatic bismaleimides may be used singly or in combination of two or more of them.

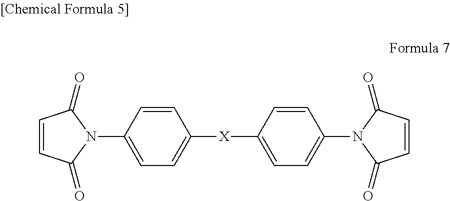

The composition according to the present invention preferably further contains a curing agent. As the curing agent, a commonly-used curing agent can be used without any limit depending on the type of the thermosetting resin used. Specific examples of the curing agent to be used include an amine-based compound, an acid anhydride-based compound, an amide-based compound, a phenol-based compound, a thiol-based compound, imidazole, a boron trifluoride-amine complex, and a guanidine derivative. Among them, an amine-based compound, an acid anhydride-based compound, imidazole, and dicyandiamide are preferred.

Specific examples of the amine-based compound include amine-based compounds such as meta-xylylenediamine (MXDA), 1,3-bis(aminomethyl)cyclohexane (1,3-BAC), norbornane diamine (NBDA), diaminodiphenylmethane, diethylenetriamine, triethylenetetramine, tetraethylenepentamine, diaminodiphenylsulfone, isophoronediamine (IPDA), dicyandiamide, dimethylbenzylamine, and a ketimine compound, a polyamine having a polyamide skeleton synthesized from a dimer of linolenic acid and ethylenediamine, and a compound represented by Formula 8. Among them, meta-xylylenediamine (MXDA), 1,3-bis(aminomethyl)cyclohexane (1,3-BAC), norbornane diamine (NBDA), and diaminodiphenylsulfone are preferred from the viewpoint of excellent workability and high curability. Compounds represented by the following Formulas 8 and 9 and various modified products of diaminodiphenylsulfone are preferred because they have aromatic nuclei in their skeleton, high heat resistance, and a long usable time. For example, they are preferably used for prepregs.

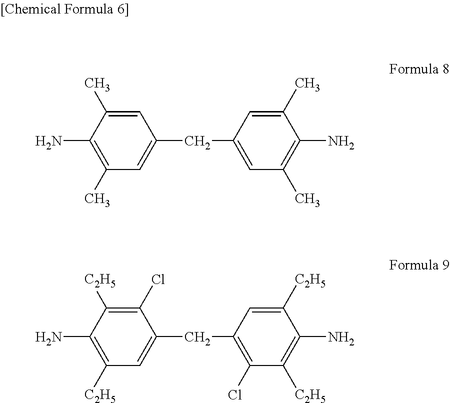 [SMILES: Cc1cc(Cc2cc(C)c(N)c(C)c2)cc(C)c1N ; CCc1cc(Cc2cc(CC)c(N)c(CC)c2Cl)c(Cl)c(CC)c1N]

Examples of the acid anhydride-based compound include phthalic anhydride, trimellitic anhydride, pyromellitic anhydride, maleic anhydride, tetrahydrophthalic anhydride, methyltetrahydrophthalic anhydride, methylnadic anhydride, hexahydrophthalic anhydride, and methylhexahydrophthalic anhydride. Among them, tetrahydrophthalic anhydride and methyltetrahydrophthalic anhydride, which are liquid at room temperature, are preferred from the viewpoint of excellent workability and high curability.

Specific examples of the phenol-based compound include biphenols and modified products thereof such as bisphenols, polycondensation products of phenols (e.g., phenol, alkyl-substituted phenol, naphthol, alkyl-substituted naphthol, dihydroxybenzene, and dihydroxynaphthalene) and various aldehydes, polymerization products of phenols and various diene compounds, polycondensation products of phenols and aromatic dimethylol, and condensation products of bis(methoxymethyl)biphenyl and naphthols or phenols.

Specific examples of the thiol-based curing agent include thiol compounds such as butanedithiols, dithiols having 5 to 10 carbon atoms, aromatic thiols, polythiols such as EPICURE QX40 (manufactured by Japan Epoxy Resin Co., Ltd.).

Specific examples of an aminobenzoate include trimethylene glycol-p-aminobenzoate and neopentyl glycol-p-aminobenzoate.

The amount of the curing agent used is preferably 0.6 to 1.2 equivalents, more preferably 0.7 to 1.0 equivalent with respect to the total amount of epoxy groups, cyanate groups, and maleimide groups in the composition.

The composition according to the present invention preferably further contains a curing catalyst. As the curing catalyst, a commonly-used curing catalyst can be used without any limit depending on the type of the thermosetting resin used. Specific examples of the curing catalyst include imidazoles such as 2-methylimidazole, 2-ethyl imidazole, 2-ethyl-4-methylimidazole, tertiary amines such as 2-(dimethylaminomethyl)phenol, 2,4,6-tris(dimethylaminomethyl)phenol, and 1,8-diaza-bicyclo(5,4,0)undecene, phosphines such as triphenylphosphine, metal compounds such as tin octylate, quaternary phosphonium salts, boron trifluoride-amine complexes, and boron trichloride-amine complexes. Among them, boron trifluoride-amine complexes and the like are preferred for their strong catalytic action.

If necessary, the composition according to the present invention may contain various additives such as a filler, a reaction retardant, an anti-aging agent, an antioxidant, a pigment (dye), a plasticizer, a thixotropy-imparting agent, an ultraviolet absorber, a flame retardant, a solvent, a surfactant (including a leveling agent), a dispersant, a dehydrating agent, an adhesion promoter, and an antistatic agent without impairing the objects of the present invention. Further, a rubber component such as nitrile rubber or carboxy-modified nitrile rubber or a thermoplastic resin such as polyethersulfone (PES), polyether ether ketone (PEEK), polyetherimide (PEI), polysulfone (PSF), polyphenylenesulfide, or nylon may be added.

Examples of the filler include organic or inorganic fillers having various shapes. Specific examples of the filler include: fumed silica, pyrogenic silica, precipitated silica, ground silica, and molten silica; diatomite; iron oxide, zinc oxide, titanium oxide, barium oxide, and magnesium oxide; calcium carbonate, magnesium carbonate, and zinc carbonate; pyrophyllite clay, kaolin clay, and calcined clay; carbon black; and fatty acid-treated products thereof, resin acid-treated products thereof, urethane compound-treated products thereof, and fatty acid ester-treated products thereof. The filler is preferably contained in an amount of 10 mass % or less of the total mass of the composition from the viewpoint of the physical properties of a resulting cured product.

Specific examples of the reaction retardant include alcohol-based compounds. Specific examples of the anti-aging agent include hindered phenol-based compounds. Specific examples of the antioxidant include butylhydroxytoluene (BHT) and butylhydroxyanisole (BHA).

Specific examples of the pigment include titanium oxide, zinc oxide, ultramarine blue, iron red, and an organic pigment such as carbon black.

Specific examples of the plasticizer include: dioctyl phthalate (DOP) and dibutyl phthalate (DBP); dioctyl adipate and isodecyl succinate; diethylene glycol dibenzoate and pentaerythritol ester; butyl oleate and methyl acetyl ricinoleate; tricresyl phosphate and trioctyl phosphate; and polypropylene glycol adipate and polybutylene glycol adipate. These plasticizers may be used singly or in combination of two or more of them. The plasticizer is preferably contained in an amount of 30 parts by mass or less per 100 parts by mass of the above-described thermosetting resin from the viewpoint of workability.

Specific examples of the thixotropy-imparting agent include AEROSIL (manufactured by NIPPON AEROSIL CO., LTD.) and DISPARLON (manufactured by Kusumoto Chemicals, Ltd.). Specific examples of the adhesion promoter include terpene resins, phenol resins, terpene-phenol resins, rosin resins, and xylene resins.

Specific examples of the flame retardant include chloroalkyl phosphates, dimethyl•methyl phosphonate, bromine•phosphorus compounds, ammonium polyphosphate, neopentyl bromide-polyether, and brominated polyether. General examples of the antistatic agent include: quaternary ammonium salts; and hydrophilic compounds such as polyglycol and ethylene oxide derivatives.

A method for producing the resin composition according to the present invention is not particularly limited. For example, a method may be used in which the above-described essential and optional components are placed in a reaction vessel and sufficiently kneaded using a stirring machine such as a mixer under a reduced pressure.

A preferred example of the method for producing the resin composition according to the present invention is a method in which at least one thermosetting resin selected from the group consisting of an epoxy resin, a cyanate resin, and a bismaleimide resin, a monomer represented by Formula 3, a monomer represented by Formula 4, a monomer represented by Formula 5, and a polymerization initiator are mixed to copolymerize, in the thermosetting resin, the monomer represented by Formula 3, the monomer represented by Formula 4, and the monomer represented by Formula 5 to generate a compound represented by Formula 1.

Another preferred example of the method for producing the resin composition according to the present invention is a method in which at least one thermosetting resin selected from the group consisting of an epoxy resin, a cyanate resin, and a bismaleimide resin, a monomer represented by Formula 3, a monomer represented by Formula 4, a monomer represented by Formula 6, and an alkyl borane or a boron compound as a polymerization initiator are mixed to copolymerize, in the thermosetting resin, the monomer represented by Formula 3, the monomer represented by Formula 4, and the monomer represented by Formula 6 to generate a compound represented by Formula 2.

These production methods are superior in workability to a method in which a compound represented by Formula 1 or 2 is produced and then mixed with the thermosetting resin, because the monomers are easily dispersed in the thermosetting resin due to their relatively low viscosity and the resulting composition also has low viscosity.

Further, such production methods make it possible to reduce VOCs and shorten a working process.

In the present invention, the use of an alkyl borane or a boron compound as a polymerization initiator for obtaining the three-dimensional copolymer makes it possible to perform polymerization at low temperature, thereby further reducing viscosity. Further, an alkyl borane or a boron compound functions as a living radical polymerization initiator, and therefore the resulting three-dimensional copolymer is less likely to have bonds that are weak against thermal decomposition. Therefore, the three-dimensional copolymer has enhanced heat resistance as compared to a case where a conventional polymerization initiator is used.

The resin composition according to the present invention makes it possible to obtain a cured product that achieves both higher heat resistance and higher toughness and mechanical strength for improving cracking resistance. Therefore, the resin composition according to the present invention can widely be used by taking advantage of its properties. More specifically, the resin composition according to the present invention is used for, for example, adhesives, coating materials, and electrical•electronic materials.

When the resin composition according to the present invention is used for, for example, an electrical device such as a motor coil, the electrical device is impregnated with the resin composition by dipping, trickle impregnation, or the like. The impregnation method is not particularly limited as long as it is an ordinary method. The thermosetting resin composition according to the present invention may be used also for the matrix of fiber-reinforced plastic or cast molding.

The thermosetting resin composition according to the present invention can be used for, for example, electrical insulation and fixation of a coil for an electrical device such as a motor or a transformer.

Hereinbelow, a coil for electrical device insulated using the resin composition according to the present invention will be described with reference to the drawings. FIG. 2 is a schematic view showing a coil for electrical device insulated using the resin composition according to the present invention. FIG. 3 is a schematic view showing the structure of a rotating electrical machine as one example of an electrical device.

As shown in FIG. 2, a coil is formed by winding a coated conductive wire 6 around a magnetic core 5 made of a metal such as iron. The composition is applied onto the wound coil by dipping, trickle impregnation, or the like. Then, the composition is cured by heating at a predetermined temperature for a predetermined time to form a cured product 7 to obtain a coil for electrical device 8 insulated using the composition.

As shown in FIG. 3, a rotating electrical machine 9 includes a cylindrical stator magnetic core 10, a rotor magnetic core 11 that coaxially rotates inside the stator magnetic core 10, and two or more coils formed by winding a coated conductive wire 6 using two or more slots 12 formed in an axial direction in one or both of the stator magnetic core 10 and the rotor magnetic core 11. The composition is applied onto stator coils 13 by dipping, trickle impregnation, or the like. Then, the composition is cured by heating at a predetermined temperature for a predetermined time to obtain a stator insulated by the composition. This stator and a rotor are assembled by a usual method to obtain the rotating electrical machine 9 using the stator coils 13 insulated using the composition. Further, the rotating electrical machine 9 includes a housing 14 that surrounds the outer periphery and side surface of the stator and accommodates the rotor so that the rotor is rotatably held within the stator.

Hereinbelow, the present invention will be more specifically descried with reference to examples. However, the present invention is not limited to the examples. <Synthesis of vinylbenzyl-ω-methyl-polyoxyethylene oxide>

First, 60 g of polyethylene glycol monomethyl ether (Mn=2000) was added to 30 mL of THF, and then 0.09 mol of a small excess amount of sodium hydride was added at room temperature in a nitrogen atmosphere. After the generation of hydrogen subsided, 22.9 g of chloromethylstyrene was added to perform a reaction at 60° C. for 15 hours to obtain vinylbenzyl-ω-methyl-polyoxyethylene oxide represented by Formula 10. This was used in the following synthesis examples and examples.

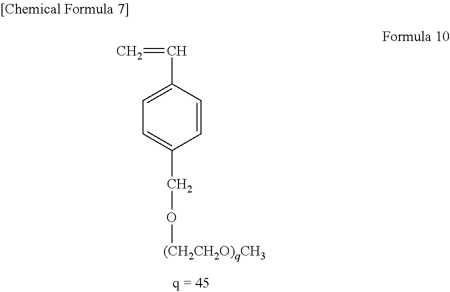

### <Synthesis of Compound According to Present Invention> (Synthesis Example 1) Synthesis of Three-Dimensional Copolymer Using Alkyl Borane or Boron Compound (1)

First, 0.07 mol of styrene, 0.1 mol of N-phenylmaleimide, 0.03 mol of vinylbenzyl-ω-methyl-polyoxyethylene oxide, and diethylmethoxyborane/1.0M THF solution (manufactured by Aldrich) used as an initiator at 1 mol % of the monomers were added to 600 mL of acetone, and the resulting mixture was stirred at 50° C. for 8 hours. Then, the thus obtained solution was subjected to reprecipitation with THF-methanol to obtain a white polymer represented by Formula 11. The thus obtained polymer was dissolved in CDCl₃ to determine its structure by ¹H-NMR using tetramethylsilane (TMS) as a reference substance. The ¹H-NMR spectrum of the compound of Synthesis Example 1 is shown in FIG. 4. From the result of ¹H-NMR, a polyether chain introduction ratio was found to be 15 mol %. Here, the polyether chain introduction ratio is the mole fraction of polyether moieties determined from a hydrogen ratio in the polymer.

The obtained polymer A had a weight-average molecular weight of 300000, a molecular weight distribution (Mw/Mn) of 2.2, and a glass transition point of 190° C. It is to be noted that the weight-average molecular weight in this description is a value determined by gel permeation chromatography based on polystyrene standards. The ratio between a and b (a/b) in the above formula was determined from the ratio between aromatic hydrogen atoms and methylene hydrogen atoms in polyether moieties determined based on the ¹H-NMR spectrum, and was found to be 85/15. Further, q was 45.

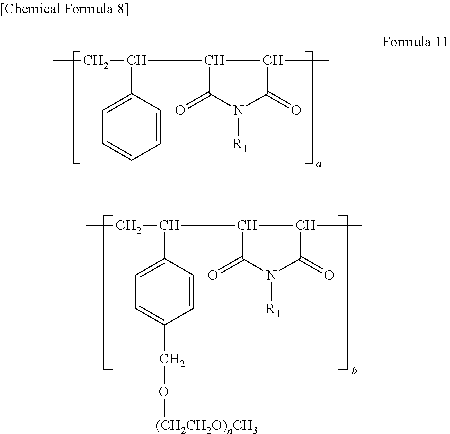

### (Comparative Synthesis Example 1) Synthesis of Three-Dimensional Copolymer Using Azo-Based Compound

First, 0.07 mol of styrene, 0.1 mol of N-phenylmaleimide, 0.03 mol of vinylbenzyl-ω-methyl-polyoxyethylene oxide, and AIBN (manufactured by KANTO CHEMICAL CO., INC.) used as an initiator at 0.01 mol % of the monomers were added to 600 mL of acetone, and the resulting mixture was stirred at 80° C. for 8 hours. Then, the thus obtained solution was subjected to reprecipitation with THF-methanol to obtain a white polymer represented by Formula 11′. The thus obtained polymer was dissolved in CDCl₃ to determine a polyether chain introduction ratio by ¹H-NMR using tetramethylsilane (TMS) as a reference substance. From the result of ¹H-NMR, the polyether chain introduction ratio was found to be 15 mol %. Here, the polyether chain introduction ratio is the mole fraction of polyether moieties determined from a hydrogen ratio in the polymer. The obtained polymer B had a weight-average molecular weight of 320000, a molecular weight distribution (Mw/Mn) of 3.2, and a glass transition point of 182° C. The ratio between a and b (a/b) in the above formula was determined from the ratio between aromatic hydrogen atoms and methylene hydrogen atoms in polyether moieties determined based on the ¹H-NMR spectrum, and was found to be 85/15. Further, q was 45.

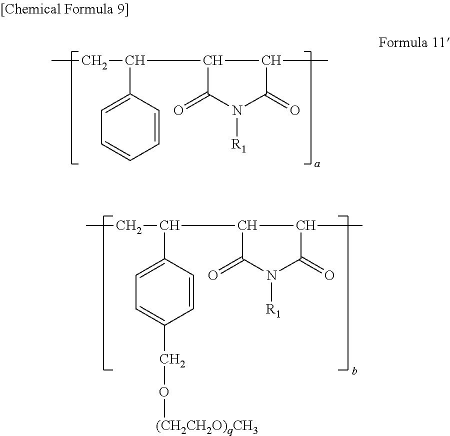

### (Synthesis Example 2) Synthesis of Three-Dimensional Copolymer Using Alkyl Borane or Boron Compound (2)

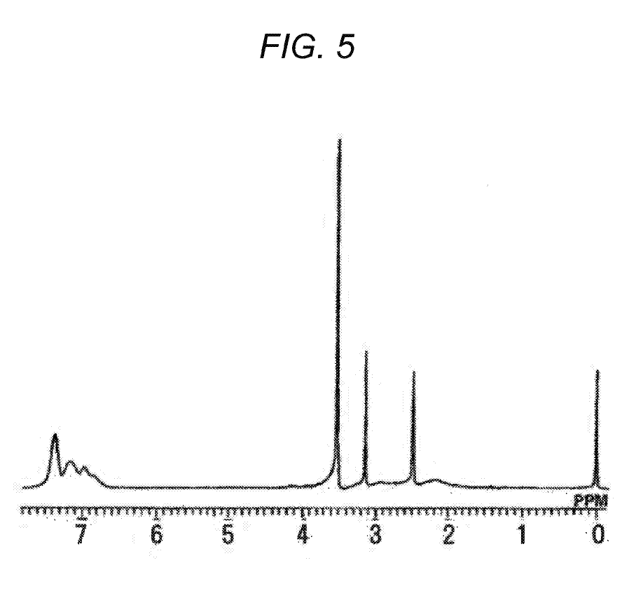

A white polymer represented by the following Formula 12 was obtained in the same manner as in Synthesis Example 1 except that 0.03 mol of ω-methyl-polyoxyethylene glycol methacrylate (manufactured by Aldrich, the same applies hereinafter) was used instead of vinylbenzyl-ω-methyl-polyoxyethylene oxide and that the reaction was performed at 50° C. for 9 hours. The ¹H-NMR spectrum of the compound of Synthesis Example 2 is shown in FIG. 5.

The thus obtained compound was dissolved in CDCl₃ to determine its structure by ¹H-NMR using tetramethylsilane (TMS) as a reference substance. From the result of ¹H-NMR, a polyether chain introduction ratio was found to be 15 mol %. The obtained polymer C had a number-average molecular weight of 350000, a molecular weight distribution (Mw/Mn) of 2.1, and a glass transition point (Tg) of 195° C. The ratio between c and d (c/d) in the formula was determined from the ratio between aromatic hydrogen atoms and methylene hydrogen atoms in polyether moieties determined based on the ¹H-NMR spectrum, and was found to be 85/15. Further, r was 45.

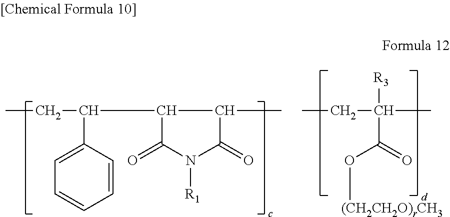

### (Comparative Synthesis Example 2) Synthesis of Three-Dimensional Copolymer Using Azo-Based Compound

A white polymer represented by the following Formula 12′ was obtained in the same manner as in Comparative Synthesis Example except that 0.03 mol of ω-methyl-polyoxyethylene glycol methacrylate (manufactured by Aldrich, the same applies hereinafter) was used instead of vinylbenzyl-ω-methyl-polyoxyethylene oxide and that the reaction was performed at 80° C. for 9 hours.

The thus obtained polymer was dissolved in CDCl₃ to determine its structure by ¹H-NMR using tetramethylsilane (TMS) as a reference substance. From the result of ¹H-NMR, a polyether chain introduction ratio was found to be 15 mol %. The obtained polymer D had a number-average molecular weight of 350000, a molecular weight distribution (Mw/Mn) of 3.5, and a glass transition point (Tg) of 188° C. The ratio between c and d (c/d) in the formula was determined from the ratio between aromatic hydrogen atoms and methylene hydrogen atoms in polyether moieties determined based on the ¹H-NMR spectrum, and was found to be 85/15. Further, r was 45.

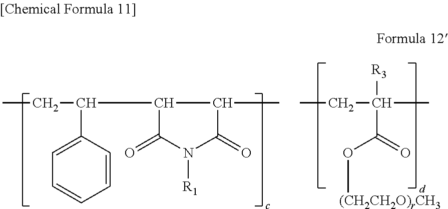

### (Examples 1 and 2) Evaluation of Heat Resistance of Three-Dimensional Copolymer

Thermogravimetric analysis was performed using a simultaneous thermogravimetric-differential thermal analyzer (SII Nano Technology Inc., TG/DTA6200) under the flow of air at a temperature increase rate of 10° C./min in a range of 30° C. to 600° C. to evaluate heat resistance based on 5% weight loss temperature. The 5% weight loss temperature of each of the polymer A represented by Formula 11 and the polymer C represented by Formula 12 was measured. The results are shown in Table 1. Both Examples 1 and have a 5% weight loss temperature of 350° C. or higher.

### Comparative Examples 1 and 2

The 5% weight loss temperature of each of the polymer B represented by Formula 11′ and the polymer D represented by Formula 12′ was measured using the same measuring device and measuring method as in Example 1. The results are shown in Table 1.

A comparison between the results of Example 1 and the results of Comparative Example 1 shows that the 5% weight loss temperature of Example 1 is higher than that of Comparative Example 1. This indicates that the three-dimensional copolymer according to the present invention obtained by living radical polymerization using an alkyl borane or a boron compound as a polymerization initiator has higher heat resistance than a conventional copolymer obtained by a radical polymerization reaction.

TABLE 1

| | | 5% weight loss |
|---|---|---|
| | Polymer | temperature (° C.) |
| Example 1 | A | 362 |
| Example 1 | C | 370 |
| Comparative Example 1 | B | 308 |
| Comparative Example 2 | D | 249 |

### Examples 3 to 10

Resin compositions containing the polymer A or C and a thermosetting resin are shown in Table 2. The resin compositions used, as their components, AER-260 (190 g/eq, manufactured by ASAHI KASEI E-materials Corp.) as an epoxy resin, MHAC-P (178 g/mol, manufactured by Hitachi Chemical Company, Ltd.) as an acid anhydride-based curing agent, 4,4′-DAS (manufactured by MITSUI FINE CHEMICALS Inc.) as an amine-based curing agent, and 2E4MZ-CN (manufactured by SHIKOKU CHEMICALS CORPORATION) as a curing catalyst. The resin compositions were cured under conditions where they were heated to 180° C. at a rate of 2° C./min and then kept at 180° C. for 2 hours to obtain test objects. Each of the obtained test objects of the compositions was matured at 85° C. for 5 hours and further matured at 150° C. for 15 hours in accordance with JIS K 7171 to prepare test pieces to measure bending strength and bending elastic modulus. The value of fracture toughness (K_{IC}) was measured in accordance with ASTM E399. The results are shown in Table 2.

The unit of numbers shown in Tables 2 and 3 as the amounts of Polymer A to 2E4MZ-CN is “parts by mass”. (Comparative Examples 3 to 7)

Test pieces were prepared using resin compositions containing 40 parts by mass of the compound A shown in Table 3 in the same manner as in Examples 3 to 10 to measure bending strength, bending elastic modulus, and the value of fracture toughness. The results are shown in Table 3.

As can be seen from the results shown in the above Table 1, the composition containing 40 parts by mass of the compound of Synthesis Example 1 (Comparative Example 4) had higher toughness than Comparative Example 3, but had lower toughness than Examples 3 to 10. Further, Comparative Examples 4 and 5 had lower bending strength than Comparative Example 2. Further, Comparative Example 6 had higher toughness than Comparative Example 5, but had lower toughness than Examples 1 to 8. Further, Comparative Example 6 had lower bending strength than Comparative Example 5. On the other hand, Examples 1 to 8 had the value of fracture toughness that was 2.3 to 2.6 times higher than that of a composition containing only the epoxy resin and 4,4′-DDS (Comparative Example 1), that is, Examples 1 to 8 were significantly excellent in toughness. Further, Examples 1 to 8 hardly showed reductions in bending strength and bending elastic modulus.

TABLE 2

| | Example 3 | Example 4 | Example 5 | Example 6 | Example 7 | Example 8 | Example 9 | Example 10 |
|---|---|---|---|---|---|---|---|---|
| Polymer A | 10 | 14 | | 10 | 5 | 20 | | |
| Polymer C | | | 10 | | | | 5 | 20 |
| AER-260 | 100 | 100 | 100 | 100 | 100 | 100 | 100 | 100 |
| MHAC-P | | | | 70 | | | 70 | 70 |
| 4,4′-DAS | 25 | 25 | 25 | | 25 | 25 | | |
| 2E4MZ-CN | | | | 0.09 | | 0.09 | 0.09 | |
| Bending strength | 145 | 133 | 143 | 135 | 146 | 133 | 138 | 133 |
| (MPa) | | | | | | | | |
| Bending elastic | 3.10 | 3.00 | 3.10 | 3.00 | 3.10 | 3.00 | 3.25 | 3.00 |
| modulus (GPa) | | | | | | | | |
| Value of fracture | 1.45 | 1.55 | 1.47 | 1.51 | 1.40 | 1.53 | 1.42 | 1.54 |
| toughness (MN/m^{3/2}) | | | | | | | | |

TABLE 3

| | Comparative | Comparative | Comparative | Comparative |
|---|---|---|---|---|
| | Example 3 | Example 4 | Example 5 | Example 6 |
| Polymer A | | 40 | | 40 |
| AER-260 | 100 | 100 | 100 | 100 |
| MHAC-P | | | 70 | 70 |
| 4,4′-DAS | 25 | 25 | | |
| 2E4MZ-CN | | | 0.09 | 0.09 |
| Bending | 147 | 110 | 138 | 105 |
| strength | | | | |
| (MPa) | | | | |
| Bending | 3.11 | 3.30 | 3.30 | 3.30 |
| elastic | | | | |
| modulus (GPa) | | | | |
| Value of | 0.60 | 1.10 | 0.61 | 1.12 |
| fracture | | | | |
| toughness | | | | |
| (MN/m^{3/2}) | | | | |

### Example 11

First, 0.09 mol of styrene, 0.1 mol of N-phenylmaleimide, and 0.01 mol of ω-methyl-polyoxyethylene glycol methacrylate were added to a bisphenol A-type epoxy resin in a total amount of 10 wt %, and were dissolved at 50° C. Then, diethylmethoxyborane/1.0M THF solution (manufactured by Aldrich) was added as a polymerization initiator at 1 mol % of the monomers, MHHPA was added as a curing agent in an amount equivalent to epoxy groups in the mixture, 0.1 g of benzyldimethylamine was added as a catalyst, and they were sufficiently dispersed. The resulting mixture was reacted at 50° C. for 5 hours, and the viscosity of the mixture at this time was measured. The viscosity was measured using an E-type viscometer manufactured by TOKIMEC INC. The measurement conditions were a rotor rotation speed of 2.5 to 100 rpm and an observation temperature of 23° C. The measurement result is shown in Table 4. (Example 12)

A resin composition was formed in the same manner as in Example except that 9-borabicyclo[3.3.1]nonane (9-BBN)/0.5M THF solution (manufactured by Aldrich) was added as a polymerization initiator at 1 mol % of the monomers, and the viscosity of the resin composition at this time was measured. The result is shown in Table 4. (Example 13)

A resin composition was formed in the same manner as in Example except that triethylborane (TEB)/0.5M THF solution (manufactured by Aldrich) was added as a polymerization initiator at 1 mol % of the monomers, and the viscosity of the resin composition at this time was measured. The result is shown in Table 4.

### Comparative Example 8

First, 0.09 mol of styrene, 0.1 mol of N-phenylmaleimide, and 0.01 mol of ω-methyl-polyoxyethylene glycol methacrylate were added to a bisphenol A-type epoxy resin in a total amount of 10 wt %, and were dissolved at 50° C. Then, AIBN was added as a polymerization initiator at 0.01 mol % of all the monomers, MHHPA was added as a curing agent in an amount equivalent to epoxy groups in the mixture, 0.1 g of benzyldimethylamine was added as a catalyst, and they were sufficiently dispersed. The resulting mixture was reacted at 100° C. for 5 hours, and the viscosity of the mixture at this time was measured. The viscosity was measured in the same manner as in Example 11. The result is shown in Table 4.

As shown in Table 4, the viscosity of Example 11 is lower than that of Comparative Example 8, from which it is found that the resin composition according to the present invention using an alkyl borane as an initiator can achieve lower viscosity.

TABLE 4

| | Viscosity (mPa · s) |
|---|---|
| Example 11 | 540 |
| Example 12 | 840 |
| Example 13 | 610 |
| Comparative Example 8 | 2230 |

### REFERENCE SIGNS LIST

1 cured resin
3 thermosetting resin composition
4 three-dimensional copolymer
5 magnetic core
6 coated conductive wire
7 cured product
8 coil for electrical device
9 rotating electrical machine
10 stator magnetic core
11 rotor magnetic core
12 slot
13 stator coil
14 housing

1. A resin composition having a bicontinuous phase structure comprising a three-dimensional copolymer and a thermosetting resin composition, wherein
the three-dimensional copolymer comprises a monomer component and a polymerization initiator and has a 5% weight loss temperature of 350° C. or higher,
a ratio between the polymerization initiator (X) and the monomer component (Y) is 0.005 to 0.1 (X/Y),
the monomer component comprises a maleimide derivative and a styrene derivative, and
the polymerization initiator comprises an alkyl borane or a boron compound.

2. The resin composition according to claim 1, wherein
the maleimide derivative comprises N-phenylmaleimide or N-cyclohexylmaleimide.

3. The resin composition according to claim 1, wherein
the three-dimensional copolymer is represented by Formula 1 or Formula 2,
R1 is any one of a phenyl group, a substituted phenyl group, a cyclohexyl group, and an alkyl group having 1 to 6 carbon atoms,
R2 is —(CH₂CH₂O)ₚR4 wherein p is an integer of 1 to 150,
R3 is a hydrogen atom or a methyl group,
R4 is any one of a phenyl group, a substituted phenyl group, a cyclohexyl group, and an alkyl group having 1 to 6 carbon atoms, a ratio between n and m (n/m) is 1000/1 to 80/20, n is an integer of 4 or more, and m is an integer of 1 or more.

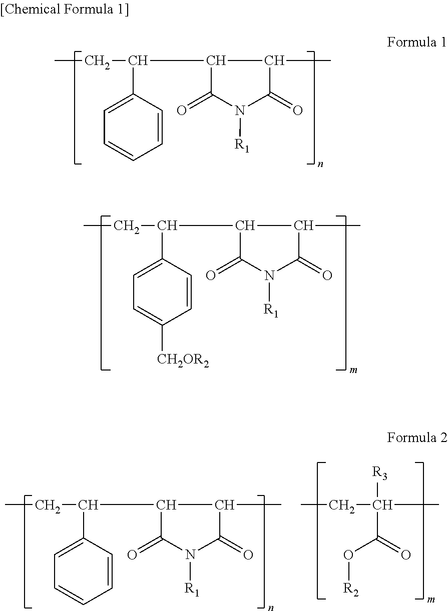

4. The resin composition according to claim 1, wherein
the thermosetting resin composition comprises at least one of an epoxy resin, a cyanate resin, a bismaleimide resin, and an unsaturated polyester resin.

5. The resin composition according to claim 1, wherein the three-dimensional copolymer is contained in an amount of 1 to 30 parts by mass per 100 parts by mass of the thermosetting resin composition.

6. The resin composition according to claim 3, wherein
the three-dimensional copolymer represented by the Formula 1 is generated by copolymerization of monomers represented by Formulas 3 to 5.

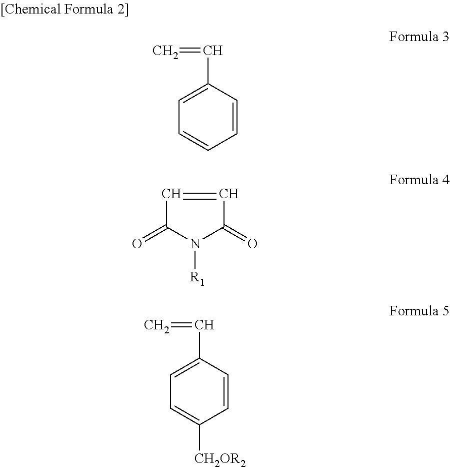

7. The resin composition according to claim 3, wherein
the three-dimensional copolymer represented by the Formula 2 is generated by copolymerization of monomers represented by Formulas 3, 4, and 6.

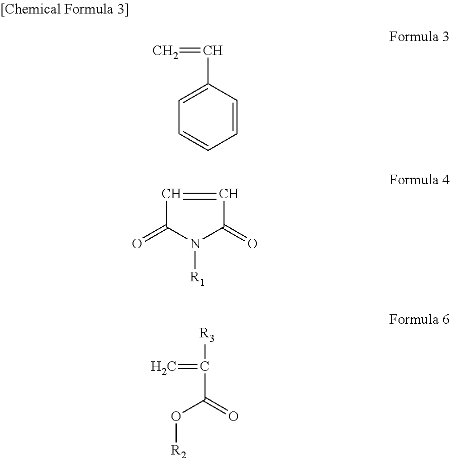

8. The resin composition according to claim 6, wherein
a reaction temperature of the copolymerization of the monomers represented by the Formulas 3 to 5 is 10 to 80° C.

9. The resin composition according to claim 7, wherein
a reaction temperature of the copolymerization of the monomers represented by the Formulas 3, 4, and 6 is 10 to 80° C.

10. The resin composition according to claim 1, wherein the three-dimensional copolymer has a weight-average molecular weight of 5000 to 700000.

11. The resin composition according to claim 1, wherein the resin composition has a viscosity of 200 to 1000 mPa·s.

12. An electrical device using a cured product of the resin composition according to claim 1 as an insulating material or a structural material.
